(19) United States
(12) Patent Application Publication
(10) Pub. No.: US 2026/0006469 A1
(43) Pub. Date: Jan. 1, 2026

(54) ENHANCEMENT ON NTN AND TN CELL SELECTION FOR POWER SAVING

(71) Applicant: APPLE INC., Cupertino, CA (US)

(72) Inventors: Yuqin Chen, Beijing (CN); Fangli Xu, Beijing (CN); Chunxuan Ye, San Diego, CA (US); Peng Cheng, Beijing (CN); Ralf Rossbach, Munich (DE); Jie Cui, San Jose, CA (US); Ping-Heng Kuo, London (GB); Naveen Kumar R Palle Venkata, San Diego, CA (US); Sethuraman Gurumoorthy, San Ramon, CA (US); Alexander Sirotkin, Hod Hasharon (IL)

(21) Appl. No.: 18/880,789

(22) PCT Filed: Aug. 3, 2022
(86) PCT No.: PCT/CN2022/109956

§ 371 Date: Jan. 2, 2025

(51) Int. Cl. H04W 24/08; H04W 48/16

(52) U.S. Cl. CPC H04W 24/08; H04W 48/16

(57) ABSTRACT

The disclosure relates to enhancement on Non-Terrestrial Network (NTN) and Terrestrial Network (TN) cell selection for power saving. In some embodiments, there is provided a user equipment (UE), comprising at least one antenna, at least one radio coupled to the at least one antenna, and a processor coupled to the at least one radio. The UE is configured to perform operations comprising: receiving from a Non-Terrestrial Network (NTN) base station one or more configurations in terms of neighbor Terrestrial Network (TN) cells and/or frequencies for Radio Resource Management (RRM) measurement available in an NTN cell, wherein the NTN base station provides one or more beams within the NTN cell, and each configuration is beam specific; and selecting a configuration from the one or more configurations based on a current beam in which the UE is located.

### TECHNICAL FIELD

This application relates generally to wireless communication systems, including user equipments (UEs), base stations (BSs), methods, apparatus, and medium for enhancement on Non-Terrestrial Network (NTN) and Terrestrial Network (TN) cell selection for power saving.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY

Embodiments relate to user equipments, base stations, methods, apparatus, and medium for enhancement on NTN and TN cell selection for power saving.

In some embodiments, there is provided a user equipment (UE), comprising at least one antenna, at least one radio coupled to the at least one antenna, and a processor coupled to the at least one radio. The UE is configured to perform operations comprising: receiving from a Non-Terrestrial Network (NTN) base station one or more configurations in terms of neighbor Terrestrial Network (TN) cells and/or frequencies for Radio Resource Management (RRM) measurement available in an NTN cell, wherein the NTN base station provides one or more beams within the NTN cell, and each configuration is beam specific; and selecting a configuration from the one or more configurations based on a current beam in which the UE is located.

In some embodiments, there is provided a user equipment (UE), comprising at least one antenna, at least one radio coupled to the at least one antenna, and a processor coupled to the at least one radio. The UE is configured to perform operations comprising: indicating to an NTN base station in a first RRC message a PLMN selected by the UE; and receiving from the NTN base station a configuration in terms of neighbor TN cells and/or frequencies for RRM measurement in a second RRC message, wherein the configuration is specific to the selected PLMN.

In some embodiments, there is provided a method, comprising: by a user equipment (UE), receiving from an NTN base station one or more configurations in terms of neighbor TN cells and/or frequencies for RRM measurement available in an NTN cell, wherein the NTN base station provides one or more beams in the NTN cell, and each configuration is beam specific; and selecting a configuration from the one or more configurations based on a current beam in which the UE is located.

In some embodiments, there is provided a method, comprising: by a user equipment (UE), indicating to an NTN base station in a first RRC message a PLMN selected by the UE; and receiving from the NTN base station a configuration of neighbor TN cells and/or frequencies for RRM measurement in a second RRC message, wherein the configuration is specific to the selected PLMN.

In some embodiments, there is provided an apparatus for operating a user equipment (UE), comprising: a processor configured to cause the UE to perform any method as recited previously.

In some embodiments, there is provided a non-transitory computer-readable memory medium storing program instructions which, when executed at a user equipment (UE), cause the UE to perform any method as recited previously.

In some embodiments, there is provided a base station (BS) of a Non-Terrestrial Network (NTN), comprising at least one antenna, at least one radio coupled to the at least one antenna, and a processor coupled to the at least one radio. The BS is configured to perform operations comprising: configuring for an NTN cell one or more configurations in terms of neighbor TN cells and/or frequencies for RRM measurement, wherein the BS provides one or more beams within the NTN cell, and each configuration is beam specific; and sending to a user equipment (UE) the one or more configurations.

In some embodiments, there is provided a base station (BS) of a Non-Terrestrial Network (NTN), comprising at least one antenna, at least one radio coupled to the at least one antenna, and a processor coupled to the at least one radio. The BS is configured to perform operations comprising: receiving from a user equipment (UE) indication of a PLMN selected by the UE in a first RRC message; and sending a configuration in terms of neighbor TN cells and/or frequencies for RRM measurement in a second RRC message, wherein the configuration is specific to the selected PLMN.

In some embodiments, there is provided a method, comprising: by a base station (BS) of a Non-Terrestrial Network (NTN), configuring for an NTN cell one or more configurations in terms of neighbor TN cells and/or frequencies for RRM measurement, wherein the BS provides one or more beams within the NTN cell, and each configuration is beam specific; and sending the one or more configurations to a user equipment (UE).

In some embodiments, there is provided a method, comprising: by a base station (BS) of a Non-Terrestrial Network (NTN), receiving from a user equipment (UE) indication of a PLMN selected by the UE in a first RRC message; and sending a configuration in terms of neighbor TN cells and/or frequencies for RRM measurement in a second RRC message, wherein the configuration is specific to the selected PLMN.

In some embodiments, there is provided an apparatus for operating a base station (BS), comprising: a processor configured to cause the UE to perform any method as previously recited.

In some embodiments, there is provided a non-transitory computer-readable memory medium storing program instructions which, when executed at a base station (BS), cause the BS to perform any method as previously recited.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example NTN cell providing a plurality of beams, according to embodiments disclosed herein.

FIG. 4 illustrates two example beams each covering a plurality of PLMN cells, according to embodiments disclosed herein.

FIG. 5 illustrates an example flowchart of a method performed by an NTN base station, according to embodiments disclosed herein.

FIG. 6 illustrates an example flowchart of a method performed by a UE, according to embodiments disclosed herein.

FIG. 7 illustrates an example flowchart of a method performed by an NTN base station, according to embodiments disclosed herein.

FIG. 8 illustrates an example flowchart of a method performed by a UE, according to embodiments disclosed herein.

FIG. 9 illustrates an example flowchart of a method performed by a UE, according to embodiments disclosed herein.

FIG. 10 illustrates an example flowchart of a method performed by an NTN base station, according to embodiments disclosed herein.

FIG. 11 illustrates an example flowchart of a method performed by an NTN base station and a UE, according to embodiments disclosed herein.

FIG. 12 illustrates an example flowchart of a method performed by a UE, according to embodiments disclosed herein.

FIG. 13 illustrates an example flowchart of a method performed by a UE, according to embodiments disclosed herein.

FIG. 14 illustrates an example flowchart of a method performed by a UE, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

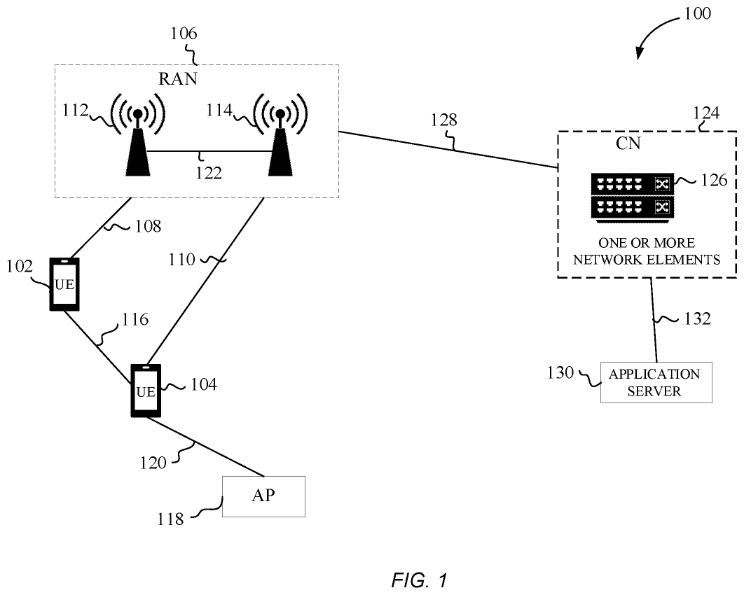

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR. In a case that the RAN 106 is an NTN-based NG-RAN architecture, the connection 108 and connection 110 are NR Uu interfaces.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (Si-U) interface, which carries traffic data between the base station 112 or base station 114 and a serving gateway (S-GW), and the Si-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

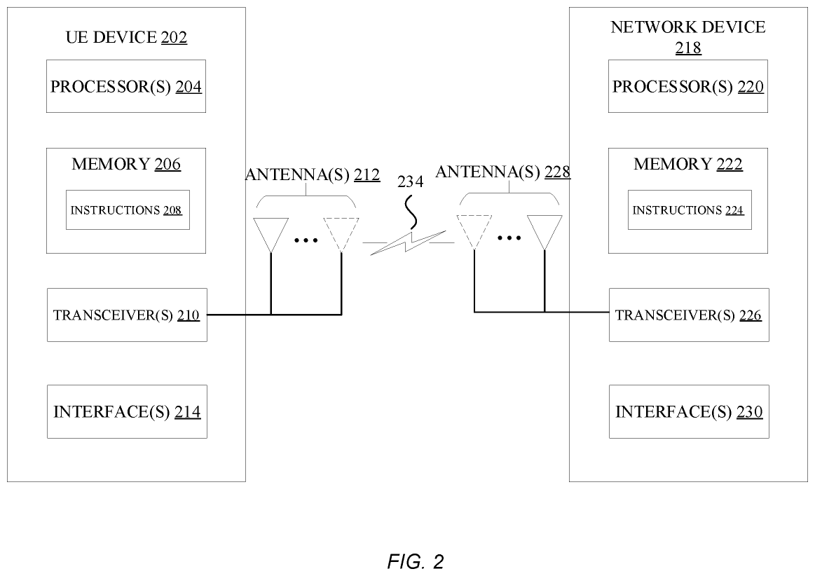

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-IMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform IMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

Satellites maximize the inherent value of 5G networks by solving coverage problems and providing difficult use-cases that ground-based infrastructure alone cannot address. 5G standards make Non-Terrestrial Networks (NTNs)—including satellite segments—a recognized part of 5G connectivity infrastructure.

NTN is used to deliver 5G/NR service via space (satellite) or air (airborne platform) to those places where it is technically very difficult or cost too much to deliver with a terrestrial network (TN). Some examples of those places would be a remote area like deep forest that would be too costly with terrestrial delivery, or far islands or ships that would be technically almost forbidden in terrestrial connection.

In Non-Terrestrial Networks, the coverage of a cell or a beam is typically much larger than a cell in Terrestrial Networks. The coverage of an NTN cell or an NTN beam may be across multiple countries. An NTN network may broadcast multiple Public Land Mobile Networks (PLMNs) and multiple Tracking Area Codes (TACs) per PLMN (up to a total of 12) in one NTN cell.

In current configurations for NTN SIB, TN frequencies are prioritized since TN cells can provide high data rate and throughput. For a NR inter-frequency or inter-RAT frequency with a reselection priority higher than the reselection priority of the current NR frequency, the UE is expected to perform measurement of the NR inter-frequency or inter-RAT frequencies with the higher priority.

The NTN cell is very large thus the neighbor TN cells can be a lot. Hence, a huge number of TN frequencies are available and configured for NTN SIB.

A UE may always perform a cell search on TN cells if a huge number of TN frequencies are configured with higher priority, leading to high power consumption. In some cases, the UE may still perform a cell search on TN cells, even if the UE may be in a location where the TN cells are not deployed, e.g., desert, ocean, mountain, leading to high power consumption.

The disclosure aims to provide cell reselection enhancements for e.g., RRC_IDLE/INACTIVE UEs to reduce power consumption.

In one aspect, the disclosure leverages a beam design of an NTN cell to make a finer granularity of configuration in SIB. The NTN cell may provide a plurality of beams. The network may provide a plurality of beam specific configurations in terms of neighbor TN cells and/or frequencies for RRM measurement.

In another aspect, the disclosure considers different PLMNs. The network may provide a plurality of PLMN specific configurations in terms of neighbor TN cells and/or frequencies for RRM measurement.

In yet another aspect, the disclosure considers different slices. The network may provide a plurality of slice specific configurations in terms of neighbor TN cells and/or frequencies for RRM measurement.

A configuration may be beam specific and further PLMN specific. A configuration may be beam specific and further slice specific. A configuration may be beam specific, further slice specific and PLMN specific. A configuration may be PLMN specific and further slice specific.

In yet another aspect, the disclosure also considers relaxed RRM measurement or skipped RRM measurement under various conditions.

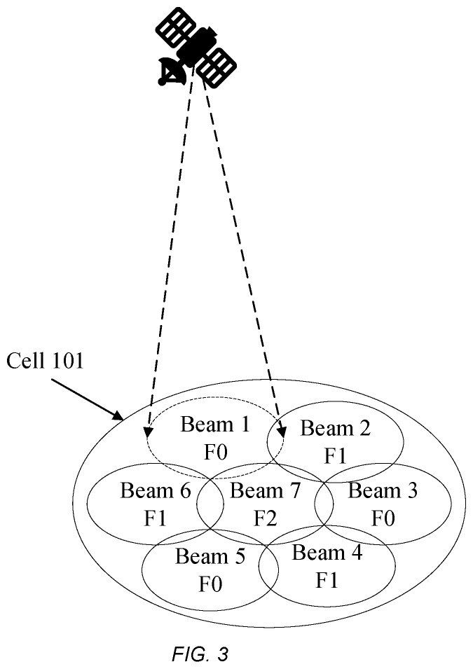

FIG. 3 illustrates an example NTN cell providing a plurality of beams, according to embodiments disclosed herein.

As shown in FIG. 3, the NTN Cell 101 is configured with 7 beams, i.e., beam 1 to beam 7, working on different frequencies.

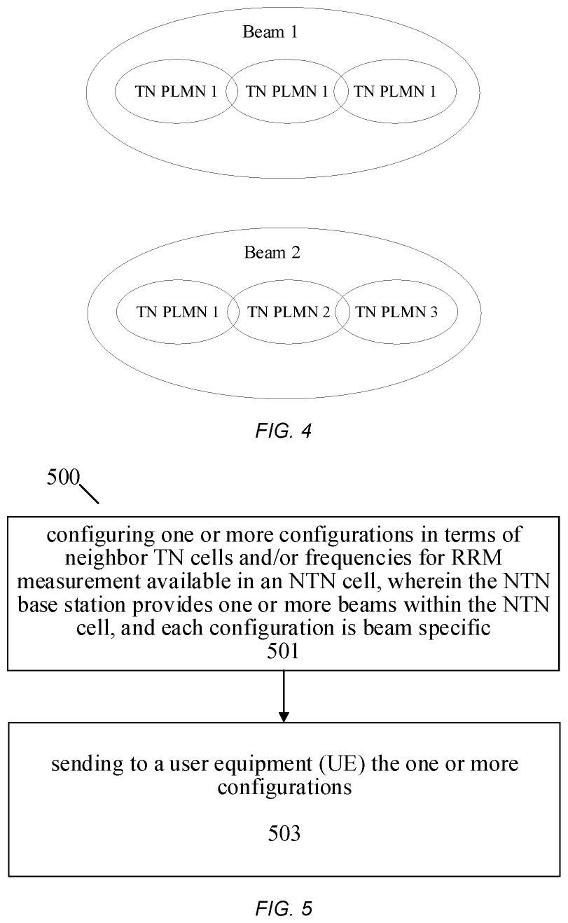

FIG. 4 illustrates two example beams each covering a plurality of PLMN cells, according to embodiments disclosed herein.

As shown in FIG. 4, within the coverage of beam 1, there are three TN cells belonging to the same TN PLMN, while within the coverage of beam 2, there are three cells belonging to three different TN PLMNs.

### Beam Specific Configurations

As shown in FIG. 3, an NTN cell may be configured with a plurality of beams. The beam design of the NTN cell may be leveraged to provide finer configurations in terms of neighbor TN cells and/or frequencies for RRM measurement. That is, the network may provide beam specific configurations. For example, each configuration may be associated with one beam. In some cases, each configuration may be associated with more than one beam. Each beam may have a corresponding configuration in terms of neighbor TN cell/frequencies for RRM measurement.

For each NTN beam or a set of NTN beams in serving cell, the network provides an intra and inter frequency list for TN cells, and for each frequency, the network provides a list of TN cells.

Taking each configuration is associated with one beam as an example. In some embodiments, the network may provide a plurality of configuration sets, with each configuration set being specific to each beam. The plurality of configuration sets may be provided in SIB, e.g., SIB3/SIB4/SIB19 or a new SIB.

An example implementation may be as follows:

{
...
beamInterFreqCarrierFreqList-TN SEQUENCE (SIZE (1..maxBeam)) OF
interFrequencyCarrierFreqList-TN
}
interFrequencyCarrierFreqList-TN::= SEQUENCE
{
beam index of NTN
interFreqCarrierFreqList-TN InterFreqCarrierFreqList-TN
}
InterFreqCarrierFreqList-TN::= SEQUENCE size of (1..N) OF InterFreqCarrier
InterFreqCarrier::= SEQUENCE {
dl-CarrierFreq
cellList
...
}

As can be seen, with respect to each beam index, a list of associated frequencies (“dl-CarrierFreq”) and Physical Cell Identifiers (PCIs) (“cellList”) are provided.

In some other embodiments, the network may provide a list of common configuration sets comprising all configurations applicable in the NTN cell, with each configuration associating with one beam.

An example implementation may be as follows:

Common list
{
...
interFrequencyCarrierFreqList-TN::= SEQUENCE size (1..M) OF
InterFreqCarrierFreqList-TN
}
InterFreqCarrierFreqList-TN::= SEQUENCE size (1..N) OF InterFreqCarrier
InterFreqCarrier::= SEQUENCE {
dl-CarrierFreq
cellList
...
}
Association between beam index and frequency set index
{
Beam index
interFreqCarrierFreqList-TN index
}

As can be seen, all configurations with corresponding frequencies and PCIs per the NTN cell are listed and the association between a beam index and a corresponding frequency set index is provided.

FIG. 5 illustrates an example flowchart of a method 500 performed by an NTN base station, according to embodiments disclosed herein.

As shown in FIG. 5, the method 500 may comprise operation 501, at which the base station configures one or more configurations in terms of neighbor TN cells and/or frequencies for RRM measurement available in an NTN cell, wherein the NTN base station provides one or more beams within the NTN cell, and each configuration is beam specific.

As recited above, the base station may configure all available configurations in the NTN cell with each configuration having a tag associating to a beam index. Each configuration may be associated with one beam. In some embodiments, each configuration may include a beam index and a set of TN frequencies and related PCIs.

The method 500 may further comprise operation 503, at which the base station sends to a user equipment (UE) the one or more configurations. The base station may broadcast the configurations within the NTN cell via SIB. A UE in the NTN cell may receive the configurations.

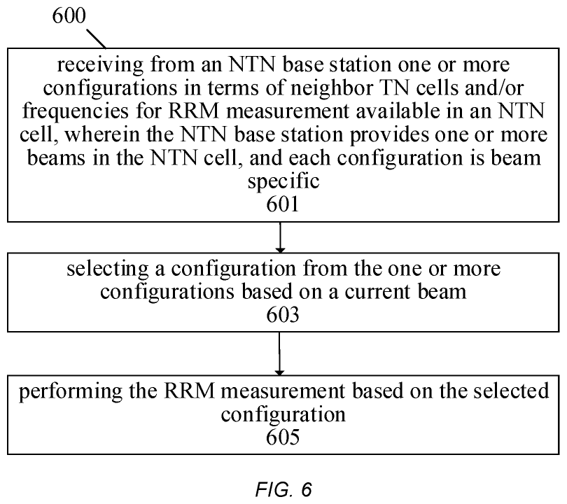

FIG. 6 illustrates an example flowchart of a method 600 performed by a UE, according to embodiments disclosed herein.

As shown in FIG. 6, the method 600 may comprise operation 601, at which the UE receives from an NTN base station one or more configurations in terms of neighbor TN cells and/or frequencies for RRM measurement available in an NTN cell, wherein the NTN base station provides one or more beams in the NTN cell, and each configuration is beam specific. The one or more configurations may be received in SIB.

The method 600 may further comprise operation 603, at which the UE selects a configuration from the one or more configurations based on a current beam in which the UE is located. For example, the UE may select the configuration based on a beam index of the current beam. A configuration associated with a beam may comprise neighbor TN frequencies and cells on which a UE shall perform RRM measurement when the UE is located within the beam.

The beam index of the current beam may be determined from Synchronization Signal and PBCH block (SSB) index received by the UE from the NTN base station. Though not shown, the operation 603 may further comprise determining a beam index of the current beam and selecting the configuration from the one or more configurations based on the determined beam index.

The method 600 may further comprise operation 603, at which the UE may perform the RRM measurement based on the selected configuration. The UE may perform the RRM measurement only on the neighbor TN frequencies and cells as indicated in the selected configuration.

With beam specific configurations, the UE performs RRM measurement only on neighbor TN frequencies and cells as indicated in the configuration associated with the beam in which the UE is located, rather than all neighbor TN frequencies and cells within the NTN cell. Hence, the power consumption can be reduced.

### PLMN Specific Configurations

As shown in FIG. 4, within the coverage of one beam, there may be many cells belong to different PLMNs. The network may provide PLMN specific configurations. The UE may only consider configurations including neighbor TN cells and/or frequencies which belong to its Home PLMN (HPLMN)/Registered PLMN (RPLMN)/Equivalent PLMN (EPLMN).

In some embodiments, the configurations may be provided via SIB, e.g., SIB 19 or a new SIB.

An example implementation may be as follows:

{
...
plmnInterFreqCarrierFreqList-TN SEQUENCE (SIZE (1..maxplmn)) OF
interFrequencyCarrierFreqList-TN
}
interFrequencyCarrierFreqList-TN ::= SEQUENCE
{
Plmn id
interFreqCarrierFreqList-TN InterFreqCarrierFreqList-TN
}
InterFreqCarrierFreqList-TN ::= SEQUENCE
{
dl-CarrierFreq
cellList
...
}

As can be seen, with respect to each PLMN ID, the corresponding neighbor TN frequencies and cells are provided.

The PLMN specific configurations may be combined with the beam specific configurations.

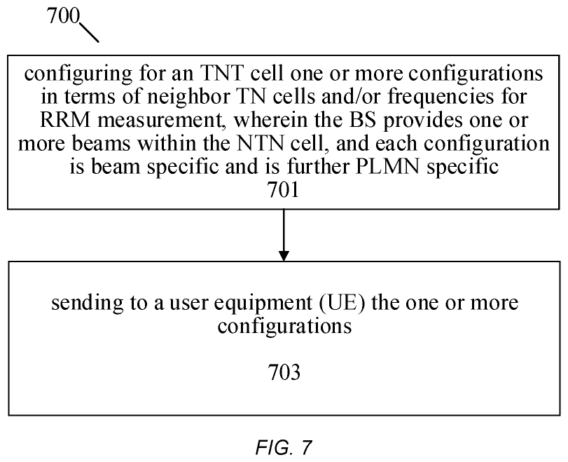

FIG. 7 illustrates an example flowchart of a method 700 performed by an NTN base station, according to embodiments disclosed herein.

As shown in FIG. 7, the method 700 may comprise operation 701, at which the base station configures for an NTN cell one or more configurations in terms of neighbor TN cells and/or frequencies for RRM measurement, wherein the BS provides one or more beams within the NTN cell, and each configuration is beam specific and is further PLMN specific.

The base station may configure a plurality of configurations available in the NTN cell with each configuration is associated with a beam index and a PLMN ID (which may include EPLMN ID). That is, each configuration may include information of TN neighbor cells and/or frequencies determined based on both the beam index and the PLMN ID. As compared to the method 500, the method 700 may provide a finer granularity of configuration in terms of TN neighbor cells and/or frequencies for RRM measurement.

The method 700 may further comprise operation 703, at which the base station sending to a user equipment (UE) the one or more configurations. The base station may broadcast the configurations within the NTN cell. A UE within the NTN cell may receive the one or more configurations.

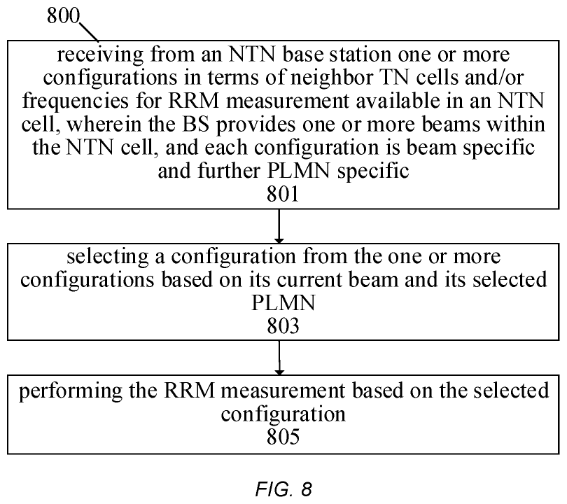

FIG. 8 illustrates an example flowchart of a method 800 performed by a UE, according to embodiments disclosed herein.

As shown in FIG. 8, the method 800 may comprise operation 801, at which the UE receives from an NTN base station one or more configurations in terms of neighbor TN cells and/or frequencies for RRM measurement available in an NTN cell, wherein the BS provides one or more beams within the NTN cell, and each configuration is beam specific and further PLMN specific.

The method 800 may further comprise operation 803, at which the UE may select a configuration from the one or more configurations based on its current beam and its selected PLMN. The UE may select the configuration according to beam index determined from SSB index and its selected PLMN ID.

The method 800 may further comprise operation 805, at which the UE may perform the RRM measurement based on the selected configuration.

The UE performs the RRM measurement only on neighbor TN frequencies and cells as indicated in the configuration selected according to both the current beam and the selected PLMN, rather than all the neighbor TN frequencies and cells within the NTN cell. Hence, the power consumption can be further reduced.

Those skilled in the art can understand that although FIGS. 7-8 show methods of PLMN specific configurations in combination with beam specific configurations, methods only applying PLMN specific configurations can be conceived under the teaching of the disclosure.

In some embodiments, the configurations may be provided via a RRC message. That is, the network can use RRC signaling to make PLMN configuration for a UE e.g., based on the PLMN (including EPLMN) ID selected by the UE.

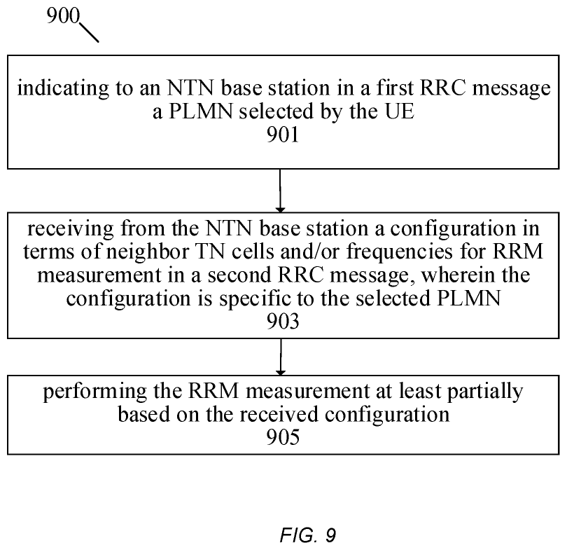

FIG. 9 illustrates an example flowchart of a method 900 performed by a UE, according to embodiments disclosed herein.

As shown in FIG. 9, the method 900 may comprise operation 901, at which the UE indicates to an NTN base station in a first RRC message (e.g., RRCSetupComplete message) a PLMN selected by the UE. The UE may indicate to the base station PLMN ID of the selected PLMN.

The method 900 may further comprise operation 903, at which the UE receives from the NTN base station a configuration in terms of neighbor TN cells and/or frequencies for RRM measurement in a second RRC message (e.g., RRCRelease message), wherein the configuration is specific to the selected PLMN.

The method 900 may further comprise operation 903, at which the UE may perform the RRM measurement at least partially based on the received configuration.

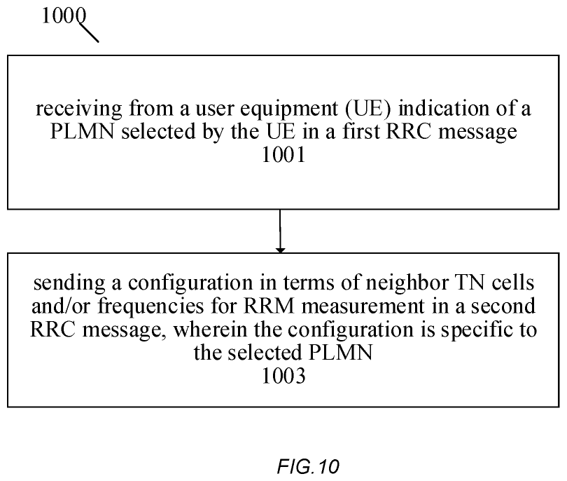

FIG. 10 illustrates an example flowchart of a method 1000 performed by an NTN base station, according to embodiments disclosed herein.

As shown in FIG. 10, the method 1000 may comprise operation 1001, at which the base station receives from a user equipment (UE) indication (e.g., PLMN ID or EPLMN ID) of a PLMN selected by the UE in a first RRC message (e.g., RRCSetupComplete message).

The method 1000 may further comprise operation 1003, at which the base station sends a configuration in terms of neighbor TN cells and/or frequencies for RRM measurement in a second RRC message, wherein the configuration is specific to the selected PLMN. The base station may configure the neighbor TN cells and/or frequencies for RRM measurement for the UE at least based on its selected PLMN.

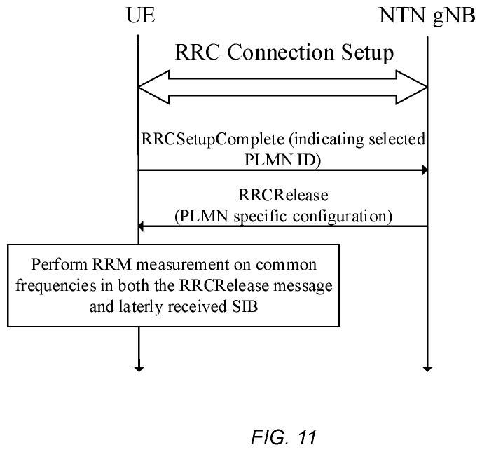

FIG. 11 illustrates an example flowchart of a method 1100 performed by an NTN base station and a UE, according to embodiments disclosed herein.

As can be seen in FIG. 11, after the RRC connection is setup, the UE may indicate to the NTN gNB its selected PLMN ID in RRCSetupComplete message.

The gNB may send to the UE the PLMN specific configuration in RRCRelease message. The gNB may configure the PLMN specific configuration based on the selected PLMN ID. The PLMN specific configuration indicates neighbor TN frequencies and cells for RRM measurement, which are associated with the selected PLMN.

Then, the UE may perform RRM measurement on common frequencies in both the RRCRelease message and latterly received SIB. For example, it is assumed that the PLMN specific configuration indicates neighbor TN frequencies F1, F2, F3 and F4, while the SIB latterly received by the UE only indicates frequency F1, then the UE only performs RRM measurement on frequency F1.

The SIB may be SIB 4 from a TN base station or SIB 19 from an NTN base station.

### Slice Specific Configurations

The disclosure also considers different slices. The network can configure a list of slice specific neighbor TN cells and/or frequencies. The UE may only consider TN neighbor cells and/or frequencies corresponding to its interested slices.

In some embodiments, the configurations may be provided via SIB, e.g., SIB16 (slicing specific SIB), SIB19, or a new SIB.

The slice specific configurations may be combined with the beam specific configurations. In such a case, the base station may configure a plurality of configurations in terms of neighbor TN cells and/or frequencies for RRM measurement, each configuration may be associated with one beam and one slice.

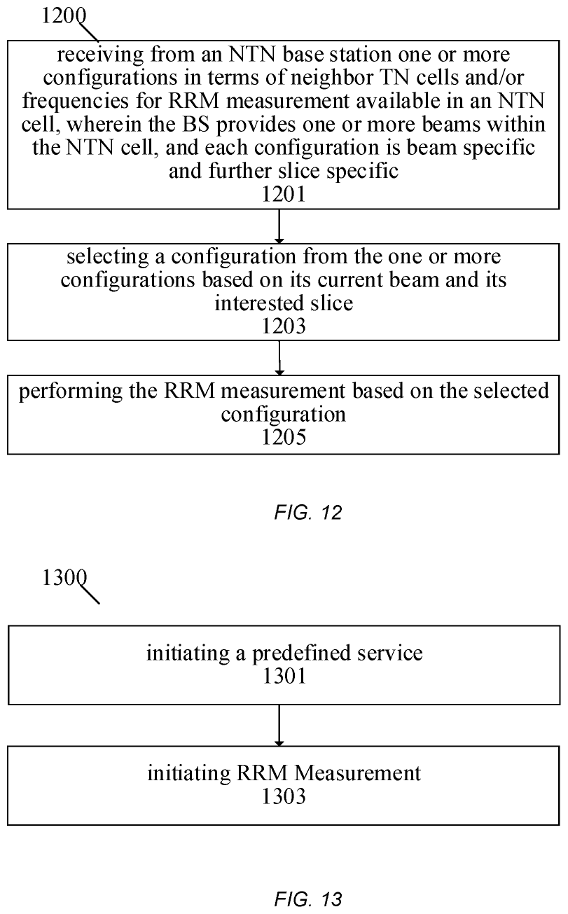

FIG. 12 illustrates an example flowchart of a method 1200 performed by a UE, according to embodiments disclosed herein.

As shown in FIG. 12, the method 1200 may comprise operation 1201, at which the UE receives from an NTN base station one or more configurations in terms of neighbor TN cells and/or frequencies for RRM measurement available in an NTN cell, wherein the BS provides one or more beams within the NTN cell, and each configuration is beam specific and further slice specific. Each configuration may be associated with a beam index and a slice ID.

The method 1200 may further comprise operation 1203, at which the UE selects a configuration from the one or more configurations based on its current beam and its interested slice. The UE may select the configuration based on a beam index of the current beam and selected slice ID.

The method 1200 may further comprise operation 1205, at which the UE performs the RRM measurement based on the selected configuration.

In some embodiments, the slice specific configurations may be combined with the PLMN specific configurations. In such a case, the configurations sent from the base station to the UE may be PLMN specific and further slice specific. For example, the base station may configure a plurality of configurations in terms of neighbor TN cells and/or frequencies for RRM measurement, each configuration may be associated with one PLMN and one slice. The UE may select one or more configurations from the plurality of configurations based on its PLMN and one or more interested slices.

In some embodiments, the slice specific configurations may be combined with both the beam specific configuration and the PLMN specific configurations. In such a case, the configurations sent from the base station to the UE may be beam specific, PLMN specific and further slice specific. For example, the base station may configure a plurality of configurations in terms of neighbor TN cells and/or frequencies for RRM measurement, each configuration may be associated with one beam, one PLMN and one slice. The UE may select one or more configurations from the plurality of configurations based on its current beam, its PLMN and one or more interested slices.

In some embodiments, the configurations may be provided via RRC signaling.

The network may use e.g., RRCRelease message to make slice specific configuration on TN frequencies/neighbors. The network may configure UE with a list of slice specific TN frequencies/neighbors per UE registered PLMN as indicated in RRCSetupComplete message.

The slice specific configurations may be combined with PLMN specific configurations.

For example, the base station may send in RRCRelease message to the UE a configuration in terms of neighbor TN cells and/or frequencies, which is associated with the PLMN selected by the UE and one or more slices configured for the UE. That is, the configuration is specific to the selected PLMN and further specific to the slices.

The UE, after receiving the configuration, the UE may perform RRM measurement on common frequencies both in the received RRCRelease message and in the latterly received SIB.

### Relaxed TN Cell Search Requirements

In some embodiments, a UE only initiates TN measurement when needed. Otherwise, the UE does not perform (i.e., skips) RRM measurement to TN frequencies/cells. For example, when the UE initiates non-emergency services (i.e., UE initiates services for entertainment services like streaming), the UE initiates TN measurement. In other words, that when should the UE start the RRM measurement could be determined by the UE's implementation, e.g., whether a user turns on a video APP.

FIG. 13 illustrates an example flowchart of a method 1300 performed by a UE, according to embodiments disclosed herein.

As shown in FIG. 13, the method 1300 comprises operation 1301, at which the UE initiates a predefined service. The predefined service may be a non-emergency data service, e.g., initiating a video APP.

The method 1300 may further comprise operation 1305, at which the UE initiates RRM measurement in response to the UE initiates the predefined service.

In some embodiments, in response to the UE initiates the predefined service, the UE may begin to perform operations of the methods previously recited, e.g., these methods recited with reference to FIGS. 6, 8, 9 and 12.

In some embodiments, the UE may perform relaxed RRM measurement to TN frequencies which may have higher priority.

For example, the network may indicate if relaxed RRM measurement to TN frequencies can be applied based on at least one of the following: whether NTN cell quality (e.g., RSRP/RSRQ) is above a threshold; whether a distance between the UE's location and a reference point (e.g., the center of the NTN cell) is lower than a threshold; whether the UE's specific Koffset is lower than a threshold; whether time to a timing point (e.g., t-Service) is larger than a threshold; whether the UE's moving speed is lower than a threshold; whether the UE is not capable of certain services requiring stringent services (a list of services (or a negative list) eligible for relaxation could be predefined), or the UE's battery status. Different relaxations may be defined for different conditions or for different device type.

In response to receiving the indication, the UE may perform a relaxed measurement based on a large measurement cycle to TN frequencies. For example, the UE may define a new measurement cycle to NTN-TN measurement.

In some embodiments, the relaxed RRM measurement may be only applied to LEO (Low Earth Orbit) or MEO (Medium Earth Orbit).

In some embodiments, a scaled (relaxed) time requirement may be introduced for a UE to initiate a cell search procedure when the UE cannot find any suitable cells on intra-frequency and inter-frequency indicated in SIB. For example, if a UE gets into a coverage hole of NTN cells and TN cells (i.e., the UE is not camping on any cells) thus cannot find any suitable cells on intra-frequency and inter-frequency indicated in SIB, the time requirement for a UE to initiate a cell search procedure may be longer than e.g., 10s.

In some embodiments, a scaled allowed time period may be introduced for a UE to detect TN neighbor cells (cell detection) in total. It allows the UE to detect TN neighbor cells relatively slower.

In some embodiments, a UE only starts RRM measurement when conditions associated with “t-service” and/or “distance to a reference location is larger than a threshold” are meet.

In some embodiments, a UE performs relaxed measurement or skips the measurement when one or two conditions are met based on network configurations on “not cell edge” and “low mobility” criterion. For example, the UE may perform relaxed measurement or skip the measurement when the UE is not on cell edge, or when the UE is in low mobility. The UE can consider it is always in low mobility when neighbor frequencies are TN only. An NTN specific threshold may be introduced for determining whether the UE is in low mobility. For another example, if the UE's moving speed is lower than a threshold, the UE may be considered in low mobility.

The network may introduce in SIB on whether to allow the relaxed/or skipped RRM on equal/lower priority TN frequencies. The network may introduce in SIB on whether to allow the relaxed/or skipped RRM on higher priority TN frequency.

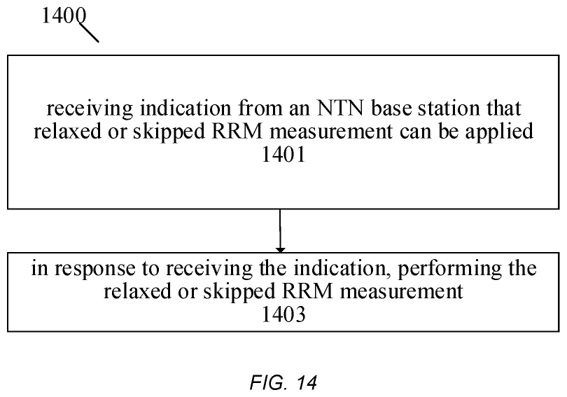

FIG. 14 illustrates an example flowchart of a method 1400 performed by a UE, according to embodiments disclosed herein.

As shown in FIG. 14, the method 1400 comprises operation 1401, at which the UE receives indication from an NTN base station that relaxed or skipped RRM measurement can be applied.

The indication may be sent based on at least one of the following: whether signal quality (e.g., RSRP/RSRQ) of an NTN cell of the NTN base station is above a first threshold; whether a distance between the UE's location and a reference point (a cell center) is lower than a second threshold; whether the UE's specific Koffset is lower than a third threshold; whether time to a serving end timing point (e.g., t-service) of the NTN cell is larger than a fourth threshold; whether UE is not capable of certain services requiring stringent services; battery status of the UE; or whether the UE is not at cell edge; or whether the UE is in low mobility.

The method 1400 may further comprise operation 1403, at which the UE, in response to receiving the indication, performs the relaxed or skipped RRM measurement.

Embodiments contemplated herein include an apparatus comprising means to perform one or more elements of the method 600, 800, 900, 1200, 1300 and 1400. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method 600, 800, 900, 1200, 1300 and 1400. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method 600, 800, 900, 1200, 1300 and 1400. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method 600, 800, 900, 1200, 1300 and 1400. This apparatus may be, for example, an apparatus of a UE (such as a wireless device 202 that is a UE, as described herein).

Embodiments contemplated herein include a signal as described in or related to one or more elements of the method 600, 800, 900, 1200, 1300 and 1400.

Embodiments contemplated herein include a computer program or computer program product comprising instructions, wherein execution of the program by a processor is to cause the processor to carry out one or more elements of the method 600, 800, 900, 1200, 1300 and 1400. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method 500, 700 and 1000. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method 500, 700 and 1000. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method 500, 700 and 1000. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method 500, 700 and 1000. This apparatus may be, for example, an apparatus of a base station (such as a network device 218 that is a base station, as described herein).

Embodiments contemplated herein include a signal as described in or related to one or more elements of the method 500, 700 and 1000.

Embodiments contemplated herein include a computer program or computer program product comprising instructions, wherein execution of the program by a processing element is to cause the processing element to carry out one or more elements of the method 500, 700 and 1000. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
at least one antenna;
at least one radio coupled to the at least one antenna; and
a processor coupled to the at least one radio;
wherein the UE is configured to perform operations comprising:
receiving from a Non-Terrestrial Network (NTN) base station one or more configurations in terms of neighbor Terrestrial Network (TN) cells and/or frequencies for Radio Resource Management (RRM) measurement available in an NTN cell, wherein the NTN base station provides one or more beams within the NTN cell, and each configuration is beam specific; and
selecting a configuration from the one or more configurations based on a current beam in which the UE is located.

2. The UE of claim 1, wherein the UE is further configured to perform operations comprising:
performing the RRM measurement based on the selected configuration.

3. The UE of claim 1, wherein each configuration is associated with a beam index and a list of neighbor TN cells and/or frequencies associated with the beam index, the UE is further configured to perform operations comprising:
determining a beam index of the current beam from SSB index; and
selecting the configuration from the one or more configurations based on the determined beam index.

4. The UE of claim 1, wherein each configuration is further Public Land Mobile Network (PLMN) specific, the UE is further configured to perform operations comprising:
selecting the configuration from the one or more configurations additionally based on its selected PLMN.

5. The UE of claim 1, wherein each configuration is further slice specific, the UE is further configured to perform operations comprising:
selecting the configuration from the one or more configurations additionally based on its interested slice.

6. The UE of claim 1, wherein the one or more configurations are received via SIB.

7. The UE of claim 1, wherein the UE is further configured to perform operations comprising:
initiating the RRM measurement only when the UE initiates a predefined service.

8. The UE of claim 1, wherein the UE is further configured to perform operations comprising:
receiving indication from the NTN base station that relaxed or skipped RRM measurement can be applied; and
in response to receiving the indication, performing the relaxed or skipped RRM measurement;
wherein the indication is sent based on at least one of the following:
whether signal quality of an NTN cell of the NTN base station is above a first threshold;
whether a distance between the UE's location and a reference point is lower than a second threshold;
whether the UE's specific Koffset is lower than a third threshold;
whether time to a serving end timing point of the NTN cell is larger than a fourth threshold;
whether UE is not capable of certain services requiring stringent services;
battery status of the UE; or
whether the UE is not at cell edge; or
whether the UE is in low mobility.

9. The UE of claim 8, the indication is sent via SIB.

10. The UE of claim 1, wherein the UE uses a relaxed time requirement to initiate a cell search procedure when the UE cannot find any suitable cells.

11. The UE of claim 1, wherein the UE uses a relaxed allowed time period for the UE to detect neighbor TN cells in total.

12. A user equipment (UE), comprising:
at least one antenna;
at least one radio coupled to the at least one antenna; and
a processor coupled to the at least one radio;
wherein the UE is configured to perform operations comprising:
indicating to an NTN base station in a first RRC message a PLMN selected by the UE; and
receiving from the NTN base station a configuration in terms of neighbor TN cells and/or frequencies for RRM measurement in a second RRC message, wherein the configuration is specific to the selected PLMN.

13. The UE of claim 12, wherein the first RRC message is RRCSetupComplete message, and the second RRC message is RRCRelease message, wherein the UE is further configured to perform operations comprising:
performing the RRM measurement at least partially based on the received configuration.

14. The UE of claim 13, wherein the UE is further configured to perform operations comprising:
receiving one or more configurations in terms of neighbor TN cells and/or frequencies for RRM measurement via SIB; and
performing the RRM measurement on common frequencies received in both the RRCRelease message and the SIB.

15. The UE of claim 13, wherein the configuration is further slice specific.

16-19. (canceled)

20. A base station (BS) of a Non-Terrestrial Network (NTN), comprising:
at least one antenna;
at least one radio coupled to the at least one antenna; and
a processor coupled to the at least one radio;
wherein the BS is configured to perform operations comprising:
configuring for an NTN cell one or more configurations in terms of neighbor TN cells and/or frequencies for RRM measurement, wherein the BS provides one or more beams within the NTN cell, and each configuration is beam specific; and
sending to a user equipment (UE) the one or more configurations.

21. The BS of claim 20, the BS is further configured to perform operations comprising:
sending indication to the UE that relaxed or skipped RRM measurement can be applied based on at least one of the following:
whether signal quality of an NTN cell of the NTN base station is above a first threshold;
whether a distance between the UE's location and a reference point is lower than a second threshold;
whether the UE's specific Koffset is lower than a third threshold;
whether time to a serving end timing point of the NTN cell is larger than a fourth threshold;
whether UE is not capable of certain services requiring stringent services;
battery status of the UE; or
whether the UE is not at cell edge; or
whether the UE is in low mobility.

22-27. (canceled)
